(19) United States
(12) Patent Application Publication
(10) Pub. No.: US 2017/0192463 A1
(43) Pub. Date: Jul. 6, 2017

(54) ELECTRONIC DEVICE

(71) Applicant: Panasonic Intellectual Property Management Co., Ltd., Osaka (JP)

(72) Inventors: HARUKA KANEKO, Osaka (JP); SHINTARO TANAKA, Osaka (JP)

(21) Appl. No.: 15/463,577

(22) Filed: Mar. 20, 2017

Related U.S. Application Data
(63) Continuation of application No. PCT/JP2015/004684, filed on Sep. 15, 2015.

(30) Foreign Application Priority Data
Sep. 29, 2014 (JP) 2014-199198

(51) Int. Cl. G06F 1/16; G06F 3/0354

(52) U.S. Cl. CPC G06F 1/1656; G06F 3/03547; G06F 1/169

(57) ABSTRACT

An electronic device of the present disclosure is a personal computer having a touchpad and an operation button that are disposed in proximity to each other at an upper surface part of a housing. The upper surface part of the housing is formed with a touchpad recessed part in which the touchpad is disposed and an operation button recessed part in which the operation button is disposed. The operation button recessed part is provided with a through hole. A support part is connected to the operation button for supporting the operation button on the housing. The support part extends out of the operation button recessed part through the through hole and is fixed on the housing.

### BACKGROUND

1. Technical Field

The present disclosure relates to an electronic device having a touchpad and an operation button that are disposed at an upper surface part of a housing.

2. Description of the Related Art

Unexamined Japanese Patent Publication No. 2004-272641 discloses an electronic device having a touchpad and operation buttons that are disposed at an upper surface part of a housing.

### SUMMARY

An electronic device of the present disclosure has a touchpad and an operation button that are disposed in proximity to each other at an upper surface part of a housing. The upper surface part of the housing is formed with a first recessed part in which the touchpad is disposed and a second recessed part in which the operation button is disposed. The second recessed part is provided with a through hole. A support part is connected to the operation button for supporting the operation button on the housing. The support part extends out of the second recessed part through the through hole and is fixed on the housing.

In the electronic device of the present disclosure, the upper surface part of the housing is formed with the first recessed part in which the touchpad is disposed and the second recessed part in which the operation button is disposed. Accordingly, a portion between the first recessed part and the second recessed part can be provided as a partition part for separating the touchpad and the operation button, so that a number of component can be lowered.

### BRIEF DESCRIPTION OF THE DRAWINGS

FIG. 1 is a perspective view of a personal computer according to a first exemplary embodiment of the present disclosure;

FIG. 2 is a partially broken enlarged plan view of a part of a main unit where a touchpad and operation buttons are disposed;

FIG. 3 is a sectional view taken along line A-A of FIG. 2;

FIG. 4 is a perspective view illustrating a state in which the touchpad and the operation buttons are removed from the personal computer of the first exemplary embodiment of the present disclosure;

FIG. 5 is an enlarged plan view illustrating the part where the touchpad and the operation buttons are disposed, with the touchpad and the operation buttons removed from the main unit;

FIG. 6 is a perspective view of an operation button member seen from above in the personal computer of the first exemplary embodiment of the present disclosure;

FIG. 7 is a perspective view of the operation button member seen from below in the personal computer of the first exemplary embodiment of the present disclosure; and

FIG. 8 is a plan view of the operation button member in the personal computer of the first exemplary embodiment of the present disclosure.

### DETAILED DESCRIPTION

Exemplary embodiments are described in detail hereinafter with reference to the accompanying drawings, as required. It is to be noted that detailed descriptions that are more than necessary may be omitted. For example, there are cases where detailed description of well-known matters and repeated description of substantially the same structure are omitted for the purpose of preventing the following description from needlessly having redundancy, thereby facilitating understanding by those skilled in the art.

It is also to be noted that the accompanying drawings and the following description are provided to allow those skilled in the art to sufficiently understand the present disclosure and thus are not intended to limit subject matters described in the claims.

### BACKGROUND THAT LED TO THE PRESENT DISCLOSURE

In an electronic device, there are cases where a touchpad and an operation button are disposed at an upper surface part of a housing. In such an electronic device, there is a case where the upper surface part of the housing is provided with, for example, a recessed part in which the touchpad and the operation button are disposed and also a partition member between the touchpad and the operation button for preventing a finger from touching an end of the touchpad during operation of the operation button. However, providing the partition member problematically results in an increased number of components. Moreover, a level difference can be caused between the touchpad and the operation button, thereby impairing operability.

To address these problems, it is conceivable that the upper surface part of the housing is formed with a first recessed part in which the touchpad is disposed and a separate second recessed part in which the operation button is disposed.

In order to impart a favorable operation feel to the operation button, it is necessary that a support part is provided for supporting the operation button on the housing. In the conventional structure, a support part is provided to extend below the touchpad from the operation button and to be fixed to a bottom face of the recessed part.

On the other hand, with the first and second recessed parts being separate from each other as described above, the support part cannot be provided to extend below the touchpad.

To cope with this, a structure of the present disclosure is such that a through hole is provided in a second recessed part, and a support part is extended out of the second recessed part through the through hole and is fixed on a housing.

In this way, an upper surface part of the housing can have a portion between a first recessed part and the second recessed part as a partition part for separating a touchpad and an operation button. Accordingly, a number of component can be lowered. Moreover, level differences can be minimized, so that deterioration of operability can be reduced. Furthermore, the support part provided to extend out of the second recessed part through the through hole and to be fixed on the housing for supporting the operation button on the housing can impart a favorable operation feel (such as a favorable click feel) to the operation button.

A description is provided hereinafter of concrete structures of the present disclosure according to the exemplary embodiments.

### FIRST EXEMPLARY EMBODIMENT

With reference to the accompanying drawings, a description is provided hereinafter of the first exemplary embodiment.

### 1. Structure

### 1-1. Overview

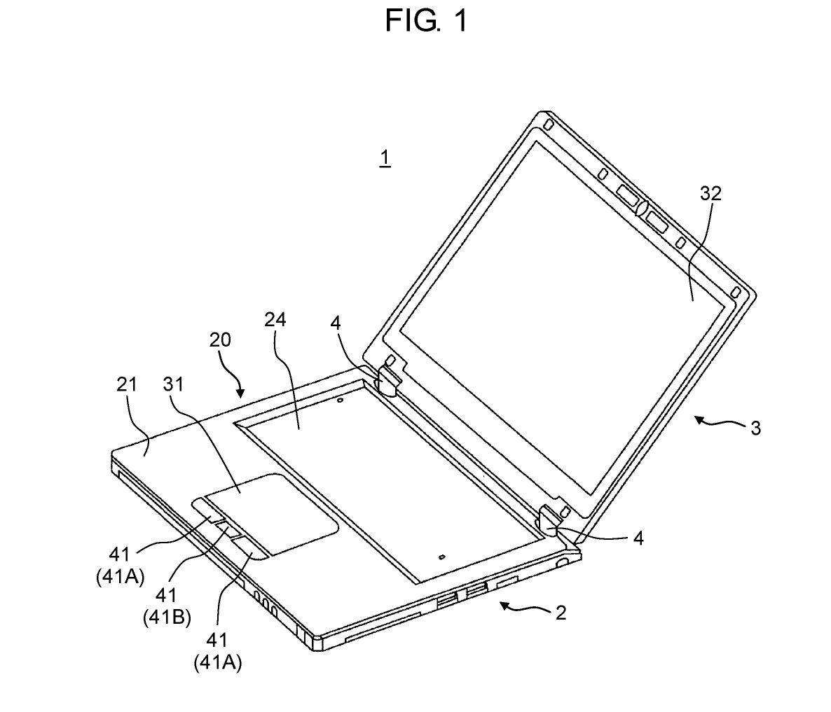

FIG. 1 is a perspective view of personal computer 1 as an example of an electronic device of the present disclosure. FIG. 1 illustrates an external view of opened laptop personal computer 1.

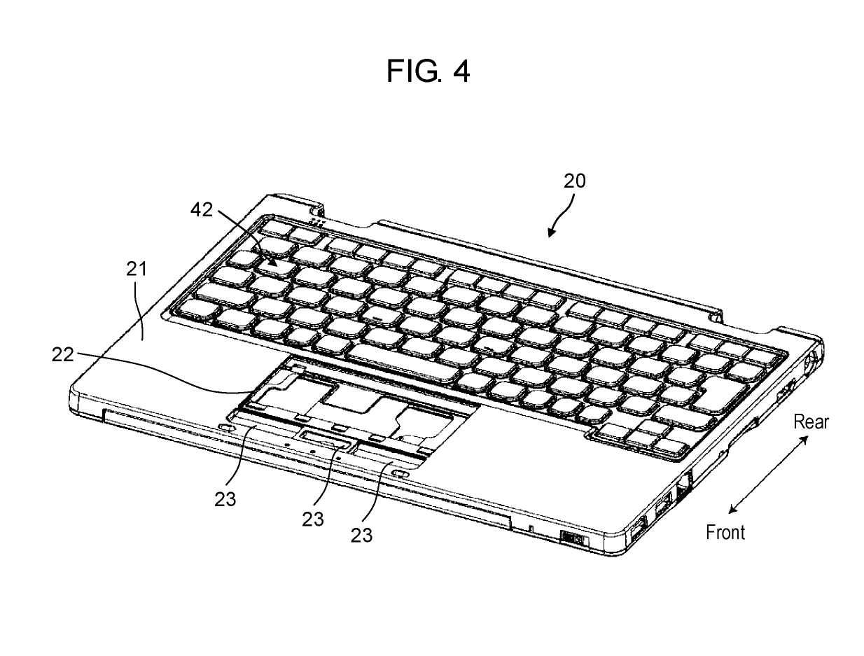

As shown in FIG. 1, personal computer 1 includes main unit 2, display unit 3, and hinge parts 4 provided between main unit 2 and display unit 3. Display unit 3 is connected to main unit 2 to be openable via hinge parts 4. Main unit 2 includes housing 20 made of metal such as magnesium alloy. An upper surface of housing 20 of main unit 2 is provided with keyboard 42 (shown in FIG. 4 and omitted in FIG. 1 where keyboard recessed part 24 in which keyboard 42 is disposed is shown instead), touchpad 31, a plurality of operation buttons 41, and others. Display unit 3 is provided with liquid crystal display (LCD) panel 32.

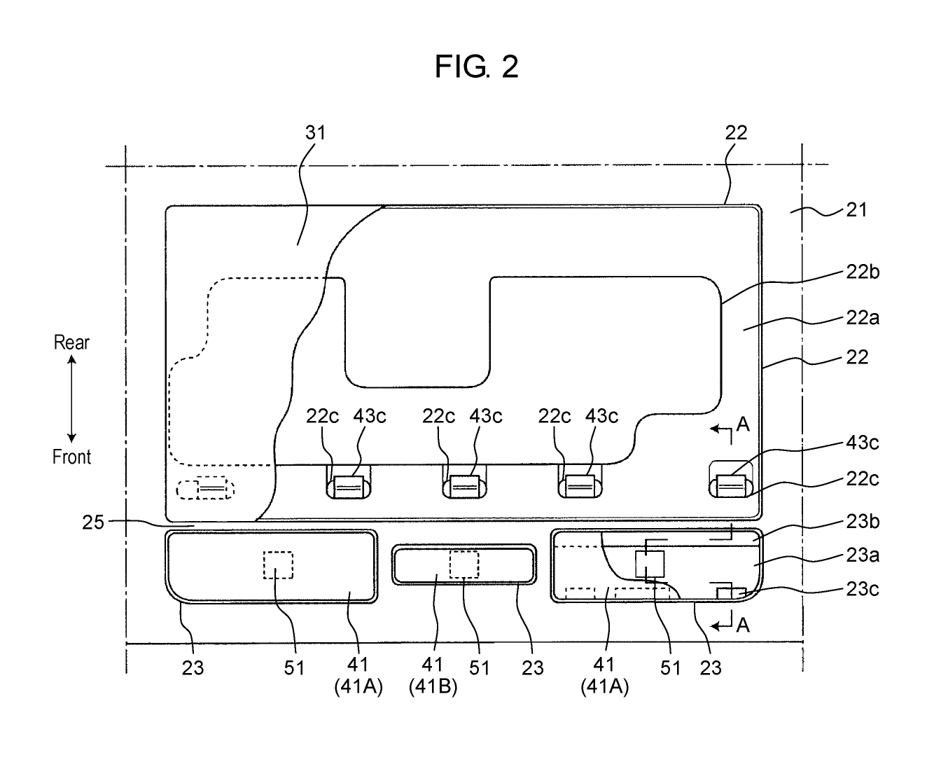

FIG. 2 is a partially broken enlarged plan view of a part of a main unit where a touchpad and operation buttons are disposed.

As shown in FIGS. 1 and 2, touchpad 31 is disposed behind the plurality of operation buttons 41 at the upper surface of housing 20.

Touchpad 31 is a member shaped like a sheet (flat plate) and accepts touch operation by a user. Upon the touch operation, touchpad 31 outputs, for example, a signal indicative of a touch and a signal indicative of a touched position.

Operation buttons 41 each accept pressing operation by the user. Switch 51 is disposed under each operation button 41 and is turned on when operation button 41 is pressed down. It is to be noted that in FIG. 1 and others, each operation button 41 shown together with reference mark 41A is a determination button for various operations, while operation button 41 shown together with reference mark 41B is a hold button for setting use of touchpad 31.

### 1-2. Structure of the Part of Housing Where Touchpad and Operation Buttons are Disposed

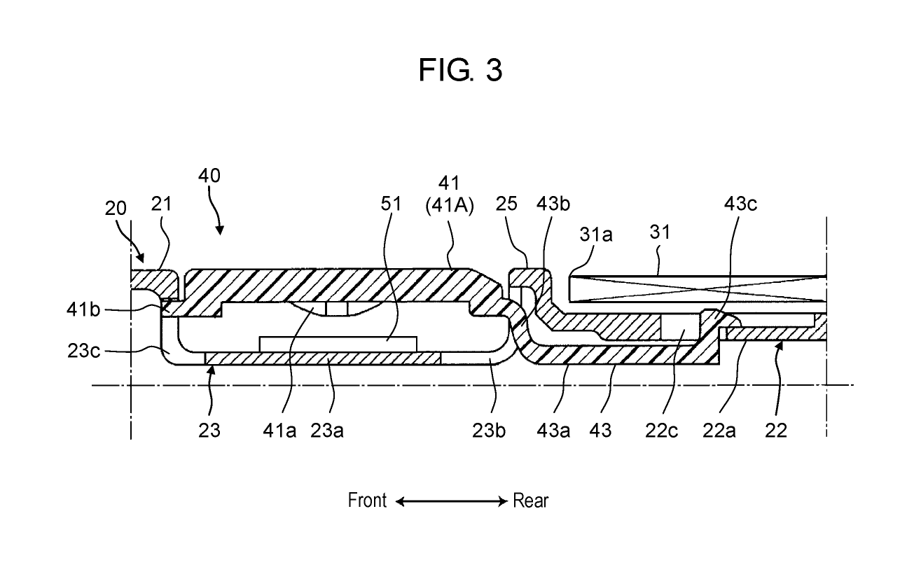

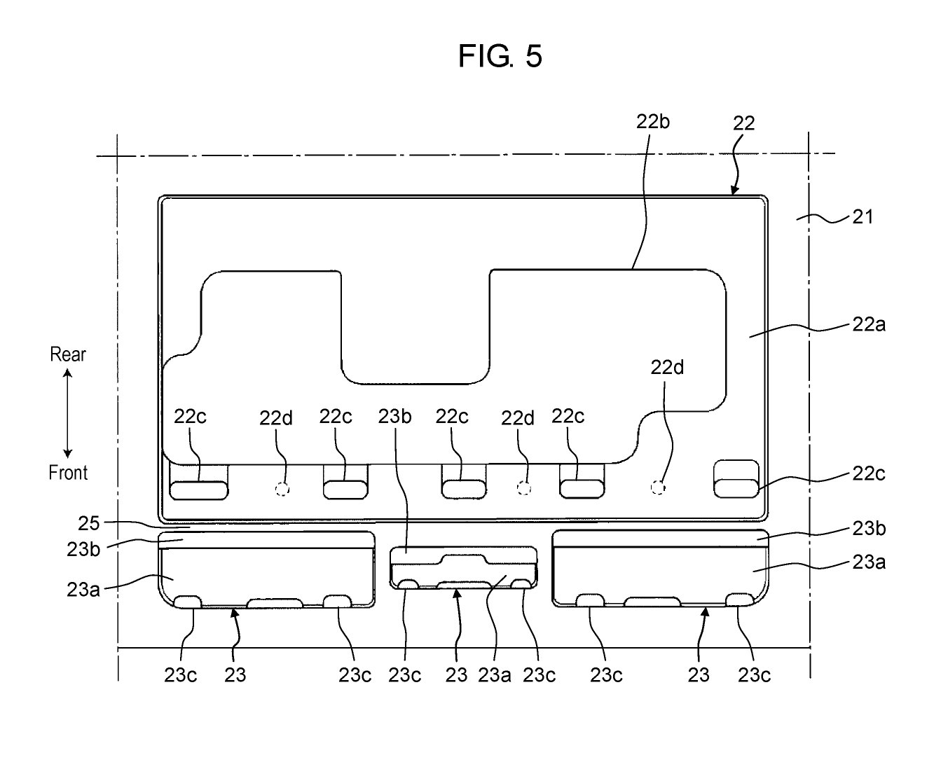

A structural description is provided of the part of housing 20 where touchpad 31 and operation buttons 41 (41A, 41B) are disposed. FIG. 3 is a sectional view (a cross section through operation button 41A) taken along line A-A of FIG. 2. FIG. 4 is a perspective view illustrating a state in which touchpad and operation buttons are removed from personal computer of the first exemplary embodiment of the present disclosure. FIG. 5 is an enlarged plan view illustrating the part where the touchpad and the operation buttons are disposed, with the touchpad and the operation buttons removed from the main unit. It is to be noted that although operation buttons 41A and operation button 41B differ slightly from one another in planar shape and size, no particular distinction is necessary for description of the technique of the present disclosure, so that operation buttons 41A and 41B are collectively described as operation buttons 41.

As shown in FIGS. 2 to 5, upper surface part 21 of housing 20 is provided with touchpad recessed part 22 in which touchpad 31 is disposed. Bottom face part 22a of touchpad recessed part 22 is provided with through hole 22b. A wire or the like for connection with touchpad 31 is passed through through hole 22b.

Upper surface part 21 of housing 20 is also provided with operation button recessed parts 23 in front of touchpad recessed part 22. Operation buttons 41 of operation button member 40 are disposed in operation button recessed parts 23, respectively. Each operation button recessed part 23 has a depth that is set to provide a favorable press feeling when the user presses down operation button 41. Bottom face part 23a of each operation button recessed part 23 has switch 51 disposed on its upper surface. Each operation button recessed part 23 is provided with through hole 23b along its end behind bottom face part 23a and through holes 23c along its end in front of bottom face part 23a.

### 1-3. Structure of Operation Button Member and Structure for Mounting Operation Button Member to Housing

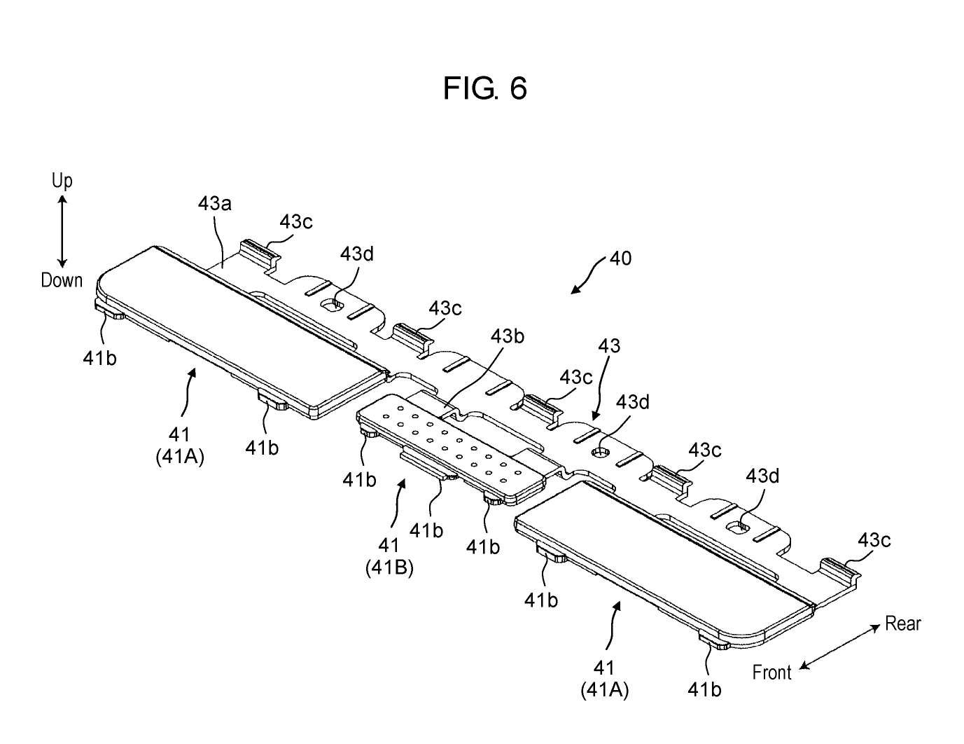

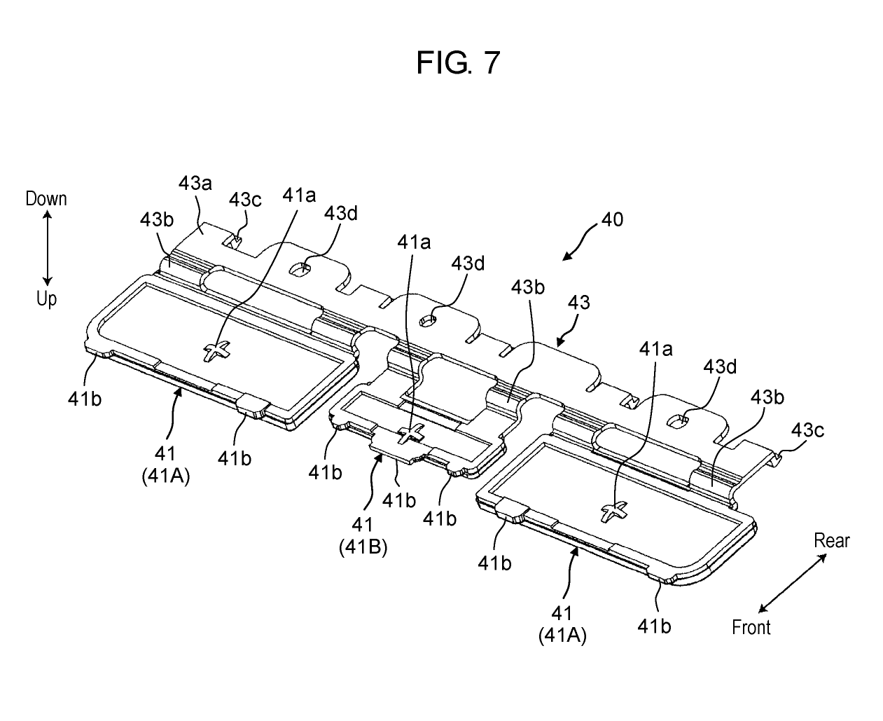

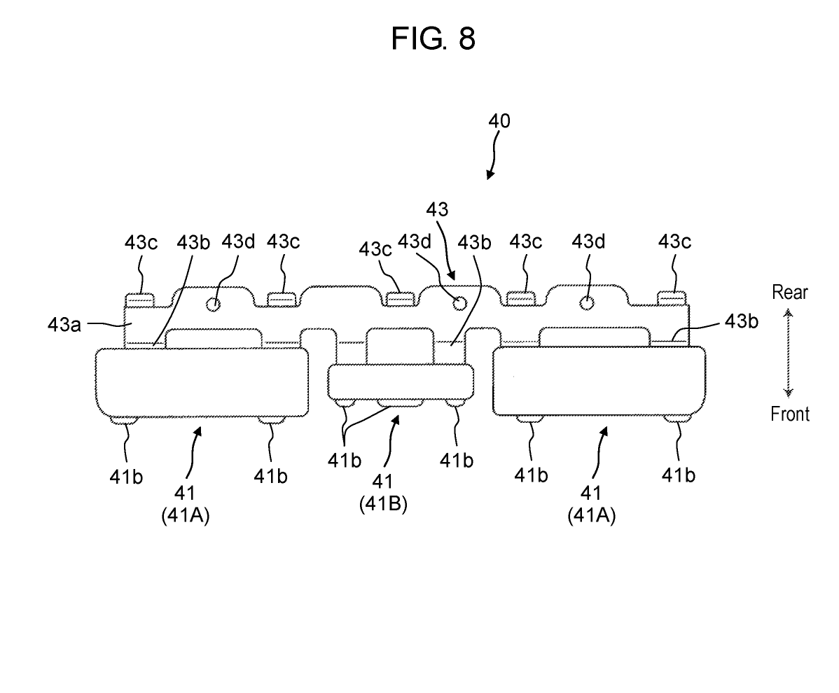

With reference to FIGS. 6 to 8 and FIG. 3, the structure of operation button member 40 and the structure for mounting operation button member 40 to housing are described. FIG. 6 is a perspective view of operation button member 40 seen from above in personal computer of the first exemplary embodiment of the present disclosure. FIG. 7 is a perspective view of operation button member 40 seen from below in personal computer of the first exemplary embodiment of the present disclosure. FIG. 8 is a plan view of operation button member 40 in personal computer of the first exemplary embodiment of the present disclosure.

Operation button member 40 includes above-mentioned operation buttons 41 and support part 43 and is formed of, for example, resin.

Each operation button 41 is shaped like a flat plate and is formed with projection 41a on its lower surface. When operation button 41 is pressed down, projection 41a abuts against switch 51, thereby turning on switch 51.

Support part 43 is connected to operation buttons 41. The support part 43 includes horizontal face part 43a and connecting parts 43b and is substantially L-shaped in cross section (refer to FIG. 3). Each connecting part 43b is substantially orthogonal to an upper surface of operation button 41 and extends downward from a rear end of operation button 41. Horizontal face part 43a is substantially parallel to the upper surface of each operation button 41 and extends rearward from respective lower ends of connecting parts 43b.

This horizontal face part 43a is provided with positioning holes 43d in its rear portion. Positioning holes 43b fit with respective projections 22d (refer to FIG. 5) formed downwardly on a lower surface of bottom face part 22a of touchpad recessed part 22, so that operation button member 40 is positioned on housing 20.

Horizontal face part 43a is also provided with engagement parts 43c along its rear end. Engagement parts 43c are substantially orthogonal to the upper surface of each operation button 41 and extend upward from the rear end of horizontal face part 43a. These engagement parts 43c have respective leading ends that are each shaped like a hook. Each engagement part 43c engages with a peripheral edge part of corresponding through hole 22c formed in bottom face part 22a of touchpad recessed part 22.

Each operation button 41 is provided with lock parts 41b along its front end. Lock parts 41b project forward from the front end of each operation button 41. Each lock part 41b engages in corresponding through hole 23c formed at the front end of operation button recessed part 23 of housing 20.

A vertical length of each through hole 23c is greater than a thickness of lock part 41b, so that lock part 41b of operation button 41 is vertically movable in through hole 23c.

A vertical length of through hole 23b in which support part 43 of operation button member 40 engages is greater than a thickness of support part 43, so that support part 43 is vertically movable in through hole 23b.

Moreover, support part 43 is set to extend a sufficiently greater distance than the vertical length of through hole 23b. Accordingly, the front end and the rear end of operation button 41 can favorably go down to reach a vicinity of a lower end position of through hole 23b when the user presses down operation button 41. This means that operation button 41 becomes easy to move vertically and can have its vertical stroke increased.

When operated by the user, operation button 41 can thus have both its front and rear ends moved vertically with a given stroke, so that a favorable operation feeling can be given to the user during the user's operation.

With regard to a position in which touchpad 31 is disposed in the structure described above, touchpad 31, upper surface part 21 of housing 20, and horizontal face part 43a of support part 43 for operation buttons 41 are disposed in this order from above in a thickness direction of the electronic device.

According to the above structure, partition part 25 is formed between touchpad 31 and operation buttons 41, being as a portion of housing 20.

### 1-4. Method for Mounting Operation Button Member and Touchpad to Housing

A description is provided of a method for mounting operation button member 40 and touchpad 31 to housing 20 with reference to FIG. 3.

First, switches 51 are mounted to respective bottom face parts 23a of operation button recessed parts 23 of housing 20 before operation button member 40 and touchpad 31 are mounted. Next, operation button member 40 is positioned below upper surface part 21 of housing 20 so that operation buttons 41 of operation button member 40 are inserted from below upper surface part 21 of housing 20 into respective operation button recessed parts 23 through respective through holes 23b. Here, lock parts 41b are engaged in respective through holes 23c. Next, positioning holes 43d of operation button member 40 are brought into engagement with respective positioning projections 22d of housing 20. Next, engagement parts 43c positioned along a leading end of support part 43 are brought into engagement with respective through holes 22c. In this way, operation button member 40 is mounted to housing 20. The structure for mounting operation button member 40 according to the present exemplary embodiment enables operation button member and others.

Next, touchpad 31 is disposed in touchpad recessed part 22 of housing 20. Here, touchpad 31 may be fixed firmly to an upper surface of bottom face part 22a of touchpad recessed part 22 through use of, for example, an adhesive or a double-sided tape, thus completing the mounting of touchpad 31 to housing 20.

### 1-5. Workings of the Present Exemplary Embodiment

In the present exemplary embodiment, partition part 25 is present as the portion of housing 20 between touchpad 31 and operation buttons 41 that are disposed at upper surface part 21 of housing 20. For this reason, when operation button 41 is pressed down, a finger of the user can be prevented from abutting on front end 31a of touchpad 31.

Conventionally, a partition member is provided separately for separating a touchpad from operation buttons. However, providing the separate member increases a number of component of an electronic device and also causes, for example, a level difference between the separate member and the touchpad as well as between the separate member and the operation buttons and a clearance between the partition member and a housing, thereby adversely affecting appearance quality and operability of the electronic device. On the other hand, partition part 25 of the present exemplary embodiment is formed as the portion of housing 20, so that a separate partition member such as provided conventionally need not be provided. Accordingly, the electronic device can have a lowered number of component. Moreover, because no partition member is provided, a clearance such as caused in the case of the partition member being provided separately is not caused between partition member and housing 20, so that favorable appearance quality and favorable operability can be obtained for the electronic device.

Furthermore, support part 43 can be provided to extend below touchpad 31, so that a favorable operation feel (such as a favorable click feel) can be imparted to each operation button 41.

When operated by the user, each operation button 41 can have both its front and rear ends moved vertically with a given stroke, so that a more favorable operation feeling can be given to the user during the user's operation.

### 2. Effects and Others

The electronic device of the present disclosure is personal computer 1 having touchpad 31 and operation buttons 41 that are disposed in proximity to one another at upper surface part 21 of housing 20. Upper surface part 21 of housing 20 is formed with touchpad recessed part (first recessed part) 22 in which touchpad 31 is disposed and operation button recessed parts (second recessed parts) 23 in which respective operation buttons 41 are disposed. Operation button recessed parts 23 are each provided with through hole 23b. Support part 43 is connected to operation buttons 41 for supporting operation buttons 41 on housing 20. The support part 43 extends out of each operation button recessed part 23 through through hole 23b and is fixed on housing 20.

In this way, upper surface part 21 of housing 20 can have the portion between touchpad recessed part 22 and operation button recessed parts 23 as partition part 25 for separating touchpad 31 from operation buttons 41. Accordingly, a number of component can be lowered.

Furthermore, with support part 43 extending out of each operation button recessed part 23 through through hole 23b and being fixed on housing 20, the favorable operation feel (such as the favorable click feel) can be imparted to each operation button 41.

In the electronic device of the present exemplary embodiment, support part 43 extends below touchpad recessed part 22 from the lower surface side of operation button recessed part 23 and is fixed to bottom face part 22a of touchpad recessed part 22.

Thus, support part 43 can have an increased length. For this reason, the vertical stroke of each operation button 41 can be increased. Consequently, the operation feel that is more favorable can be imparted to each operation button 41.

In the electronic device of the present exemplary embodiment, through holes (second through holes) 22c are provided in bottom face part 22a of touchpad recessed part 22, and support part 43 is provided with, along its leading end, engagement parts 43c for engagement with the respective peripheral edge parts of corresponding through holes 22c.

Support part 43 can thus be fixed on housing 20 without use of a fixing material such as an adhesive.

### OTHER EXEMPLARY EMBODIMENTS

The first exemplary embodiment has been described above as being illustrative of the technique of the present disclosure but is not restrictive of the technique of the present disclosure. The technique of the present disclosure is also applicable to exemplary embodiments including appropriate modifications, replacements, additions, and omissions. Moreover, the components described in the first exemplary embodiment can be combined in a new exemplary embodiment.

In the first exemplary embodiment, operation buttons 41 are disposed in front of touchpad 31, however, the present disclosure is not limited to this. Operation buttons 41 may be disposed behind touchpad 31 or to a left or a right of touchpad 31.

In the first exemplary embodiment, touchpad 31 and operation buttons 41 each have a rectangular shape in planar view, however, the present disclosure is also applicable to cases where a touchpad and operation buttons each have a shape other than the rectangular shape. For example, the touchpad and the operation buttons may each be circular or polygonal in shape.

In the first exemplary embodiment, engagement parts 43c positioned along the leading end of support part 43 of operation button member 40 each engage with the peripheral edge part of corresponding through hole 22c. However, in place of through holes 22c, housing engagement parts may be provided on the lower surface of bottom face part 22a of touchpad recessed part 22 for engagement with respective engagement parts positioned along the leading end of support part 43.

In the first exemplary embodiment, operation buttons 41 are integrally provided in operation button member 40. However, an operation button member may be provided independently for each operation button 41.

The exemplary embodiments have been described above as being illustrative of the technique of the present disclosure, and the appended drawings and the detailed description have been provided for this purpose.

For illustration of the above technique, the components shown in the appended drawings and described in the detailed description can include not only essential components but also components that are not essential. For this reason, those nonessential components that are shown in the appended drawings and described in the detailed description should not immediately be acknowledged as essential.

In addition, because the above exemplary embodiments are intended to be illustrative of the technique of the present disclosure, various modifications, replacements, additions, omissions, and others can be made within the scope of the claims or equivalents of the claims.

The present disclosure is widely applicable to electronic devices each having a touchpad and an operation button that are disposed at an upper surface of a housing.

What is claimed is:

1. An electronic device comprising a touchpad, an operation button, and a housing, the touchpad and the operation button being disposed in proximity to each other at an upper surface part of the housing,
wherein the upper surface part of the housing is formed with a first recessed part in which the touchpad is disposed and a second recessed part in which the operation button is disposed,
the second recessed part is provided with a through hole,
a support part is connected to the operation button for supporting the operation button on the housing, and
the support part extends out of the second recessed part through the through hole and is fixed on the housing.

2. The electronic device according to claim 1, wherein the support part extends below the first recessed part and is fixed to a bottom face part of the first recessed part.

3. The electronic device according to claim 2, wherein
the bottom face part of the first recessed part is provided with a second through hole, and
the support part is provided with, at a leading end of the support part, an engagement part for engagement with a peripheral edge part of the second through hole.
